(19) United States
(12) Patent Application Publication
(10) Pub. No.: US 2011/0286832 A1
(43) Pub. Date: Nov. 24, 2011

(54) Back to back turbine

(76) Inventor: Israel Ortiz, Guayama, PR (US)

(21) Appl. No.: 12/800,794

(22) Filed: May 24, 2010

(51) Int. Cl. F03B 15/06

(52) U.S. Cl. 415/4.3

(57) ABSTRACT

Since a normal turbine will not rotate in one direction with a bidirectional force, this turbine uses two turbines back to back to rectify this force. When the flow comes in one direction the turbine will present one face, when the flow reverses direction the turbine will present the other face. This is so because of this back to back design of this turbine. Each blade of this turbine has one side with a pitch angle but the back side of the blade has 0 degrees pitch that is it is flat. In other words the flat side of each blade will be facing each other and the pitch side of each blade will be facing outward. When seen from the top this back to back blade has a separation between the flat sides of the blades. This is so they will have less resistance with the air when rotating.

### FIELD OF THE INVENTION

The present invention relates to a turbine and, more particularly, to a turbine that will generate a unidirectional force from a bidirectional force.

### BACKGROUND OF THE INVENTION

The problem of generating power output from sea waves is that sea wave will generate a force that is bidirectional. Therefore, a way has to be use that can compensate or rectify this shortcoming. When a chamber is open at the bottom and has another opening at the top. Than when the water level rises it will produce a pressure in the chamber, and as a result the air flow will flow out of the chamber at the top opening. If the water level goes low, it will produce a low pressure level in the chamber and the air flow will be into the top opening. Therefore, this will produce a bidirectional force at the top opening. If a normal turbine were placed here, it would go back and forth and will produce a useless output.

There have been other solution attempts to this bidirectional force. Just to name a few.

1) One of them, the expensive check valve systems. Which use a regular turbine, but rectify the changing bidirectional force using this check valve system.

2) Also there is the Well's turbine, which will rotate in one direction no matter the directional change of the air flow.

3) And there is the turbine that has variable pitch, a project at island of Pico in the Azores, that can turn in the same direction with a bidirectional flow.

The short comings of these solutions are as follows:

1) The check valve system has too many moving parts. Therefore, they tear and wear, and evenly will need much maintenance and interruptions in the service.

2) The Well's turbine has a low efficiency because of the high angle of attack and higher drag coefficient.

3) And the turbine that changes its pitch at island of Pico in the Azores, has the same problem as the check valve system, to many moving parts, making it victim to much maintenance and power interruptions. It needs a very complex electronic and mechanical control system to change its pitch.

It is therefore an object of the invention to have few moving parts.

It is another object of the invention to produce output power from the dynamic bidirectional force of the sea waves.

It is another object of the invention to have a turbine that will not stall and will always self start.

It is another object of the invention to have a power source that will produce power 24 hours a day and 365 days a year, because of all the green power sources this is the most reliable.

It is another object of the invention to be able to produce power in the megawatt range and even higher.

### SUMMARY OF THE INVENTION

In accordance with the present invention, there is provided a turbine that will provide a unidirectional rotational force from a bidirectional force. This bidirectional force comes from sea waves. Since a normal turbine will not rotate in one direction, this turbine uses two turbines back to back to rectify this bidirectional force. When the flow comes in one direction, the turbine will present the correct pitch. When the flow reverses direction the turbine will present a different pitch but will rotate in the same direction as before. This is so because of this back to back design of this turbine. Each blade of this turbine has one side with a pitch angle but the back side of the blade has 0 degrees pitch, that is it is flat. This flat side, faces the other flat side of the second blade that is back to back with this blade, at the same time this second blade will have the other side with a pitch angle facing outward. In other words the flat side of each blade will be facing each other and the pitch side of each blade will be facing outward. When seen from the top this back to back blade has a separation between the flat sides of the blades. This is so they will have less resistance with the air when rotating.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a back to back turbine;

FIG. 2 is a left detail view of a back to back turbine, also a front view of this turbine, is shone;

FIG. 3 is an exploded view of a back to back turbine;

FIG. 4 is a detail view of a back to back blade that makes up the back to back system of this turbine, here we have eight blades but could be more;

FIG. 5 is a detail view of a back to back blade system and the air flow around the blade;

FIG. 6 is a detail view of a back to back blade from the top and the deferent sides of each blade;

FIG. 7 is a left detail view of a constant rotation on the blade, with bidirectional flow; and

FIG. 8 is a perspective view of a back to back turbine extracting power from the sea wave's dynamic power.

For purposes of clarity and brevity, like elements and components will bear the same designations and numbering throughout the Figures.

### DESCRIPTION OF THE PREFERRED EMBODIMENT

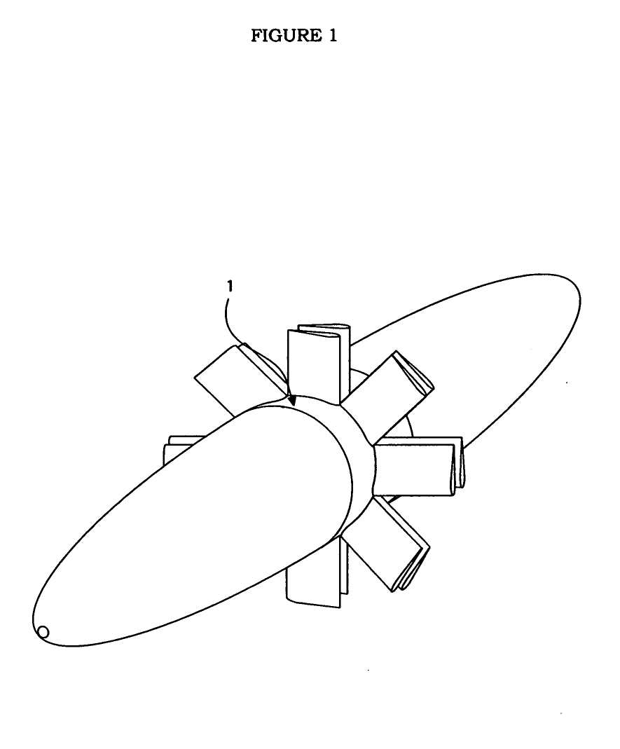

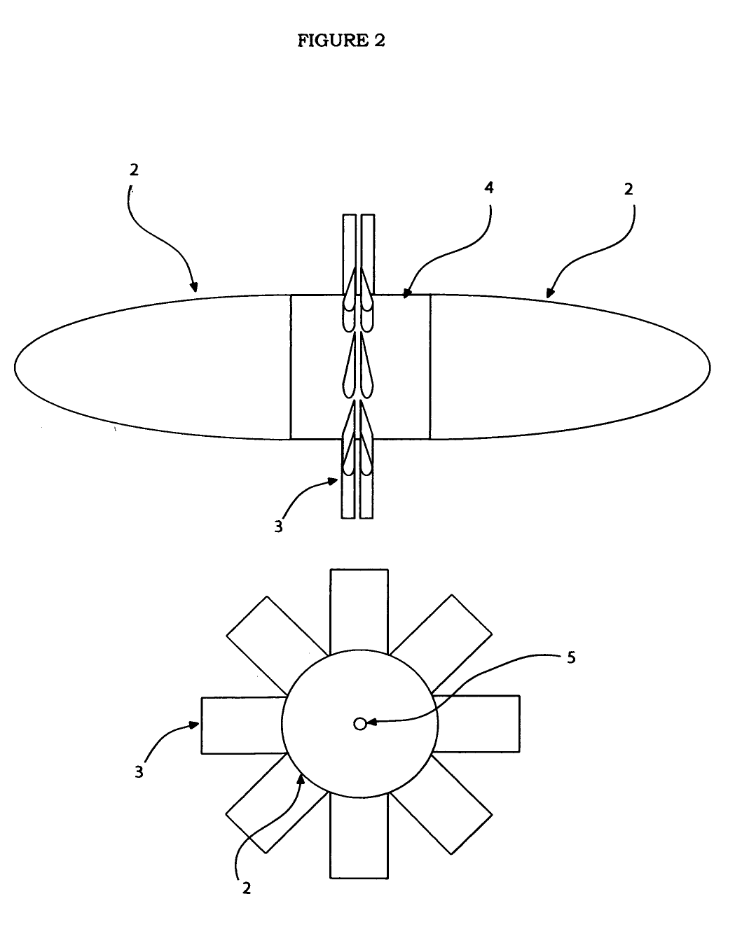

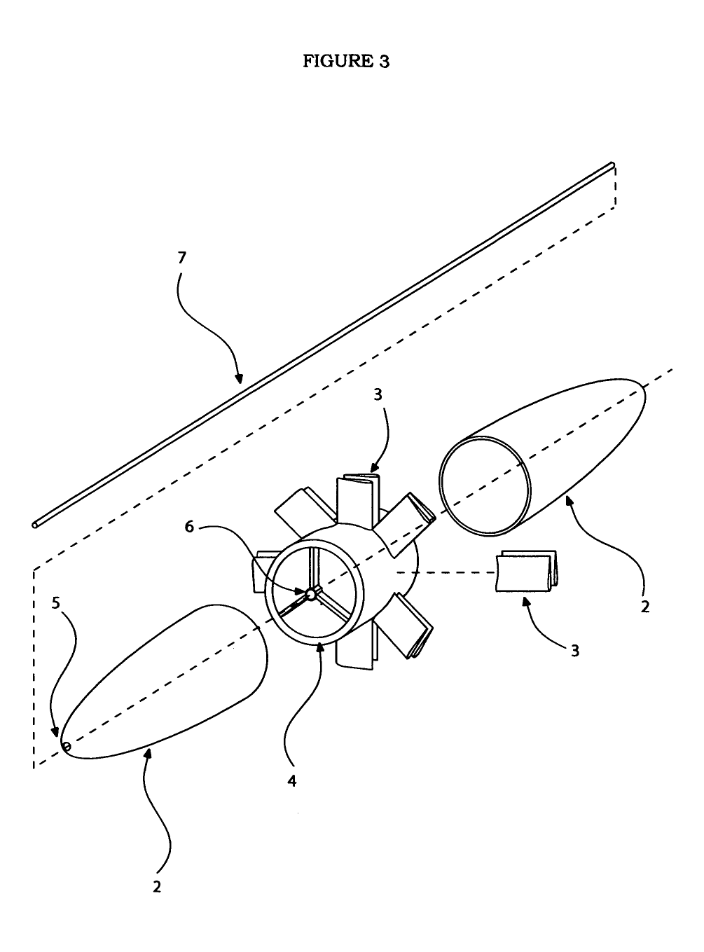

In FIG. 1 we see a perspective view of the back to back turbine 1. FIG. 2 is a side and front view. FIG. 3 is an exploded view of the different parts of this turbine. The parts of the back to back turbine 1 are two spinner 2, eight back to back blade 3 that make up the two turbines that are back to back, main body 4 and the main shaft 7 where the turbine will rotate and connects to the load.

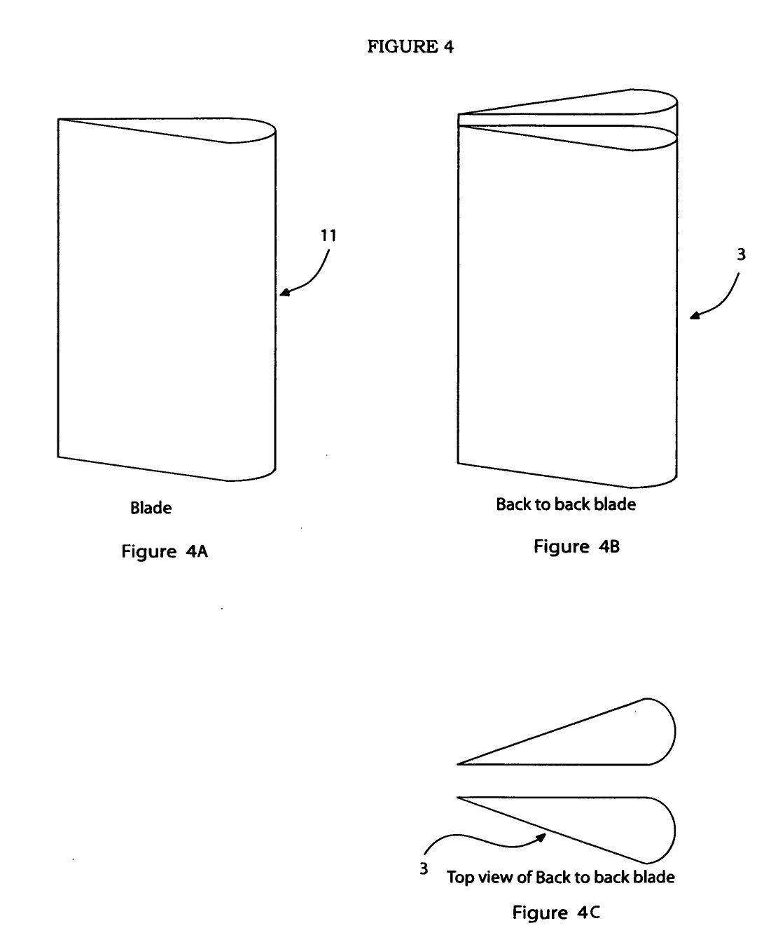

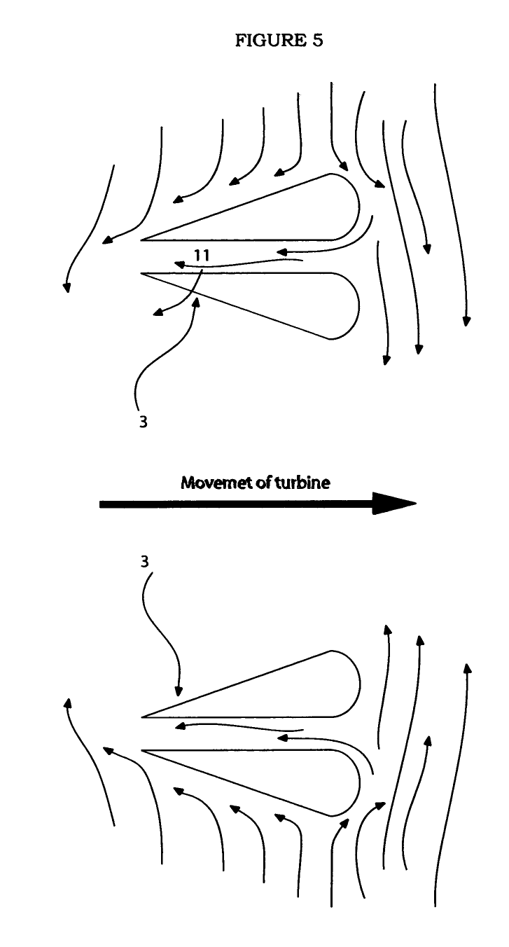

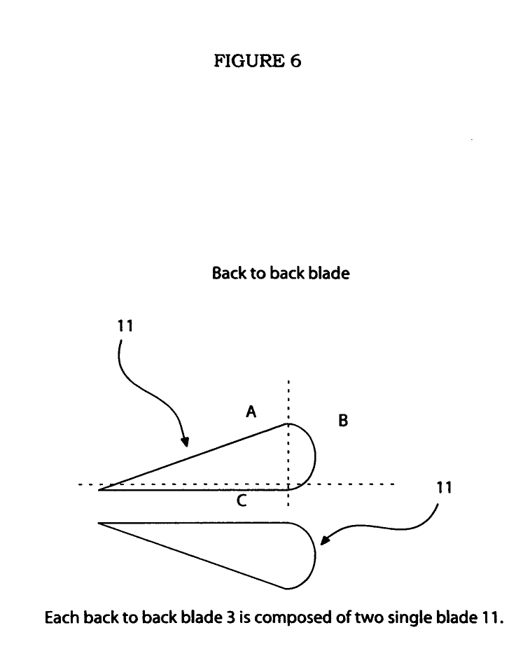

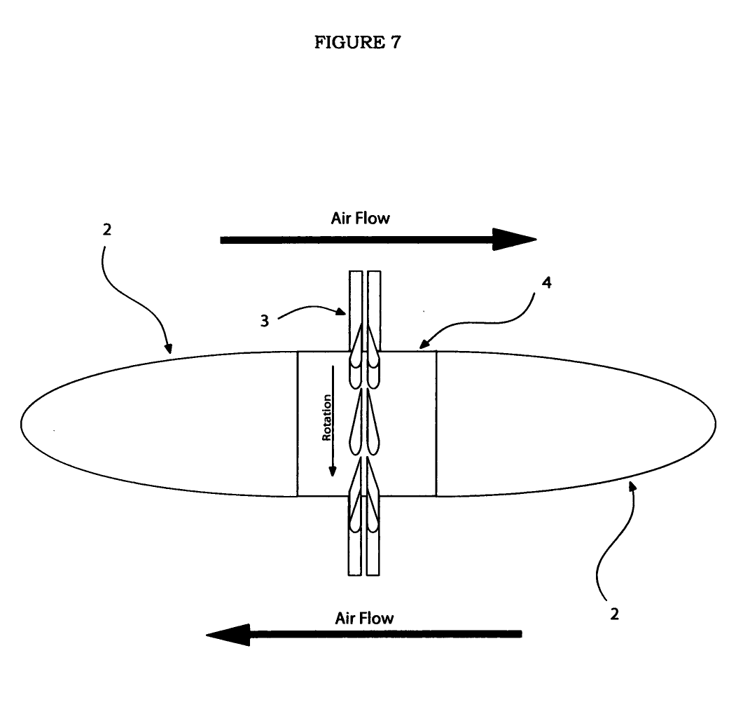

This turbine will rotate in one direction when a bidirectional flow of gas or liquid is applied. This is so because the turbine is composed of two turbines back to back as seen in FIG. 1 and FIG. 2. As seen in FIG. 5 the flow will always hit the pitch side of the back to back blade 3 arrangement. The pitch side of the back to back blade 3 will always face outward. Also as seen in FIG. 5 and FIG. 7 the bidirectional flow will always cause a rotation in the same direction. The back to back turbines are composed of this back to back blade 3 as seen in FIG. 4B and FIG. 1 which are eight but can be more in number. The back to back blade 3 is composed of two single blade 11 as seen in FIG. 4A and FIG. 4B. Beside as in FIG. 4B and FIG. 4C. the blade 11 is back to back, they also shield one another. The blade 11 is composed of three sides as seen in FIG. 6. Side A which has the pitch angle and causes the turbine to move in response to the flow, the grater this angle in relation to the flat side of the blade 11 the better the efficiency of the turbine. The flat side C is the side that has zero angle or pitch. This side is facing the other flat side of second back bade which forms the back to back blade 3. This side C is flat as to cause no interaction with the flow. Side B which has rounded corners, as to have little resistance when the blade 11 is moving in rotation with the turbine. Also there is a separation between the flat sides C of each blade 11 as to decrease this resistance. This separation acts like the double keel of a racing boat, which gives the boat less resistance with the water.

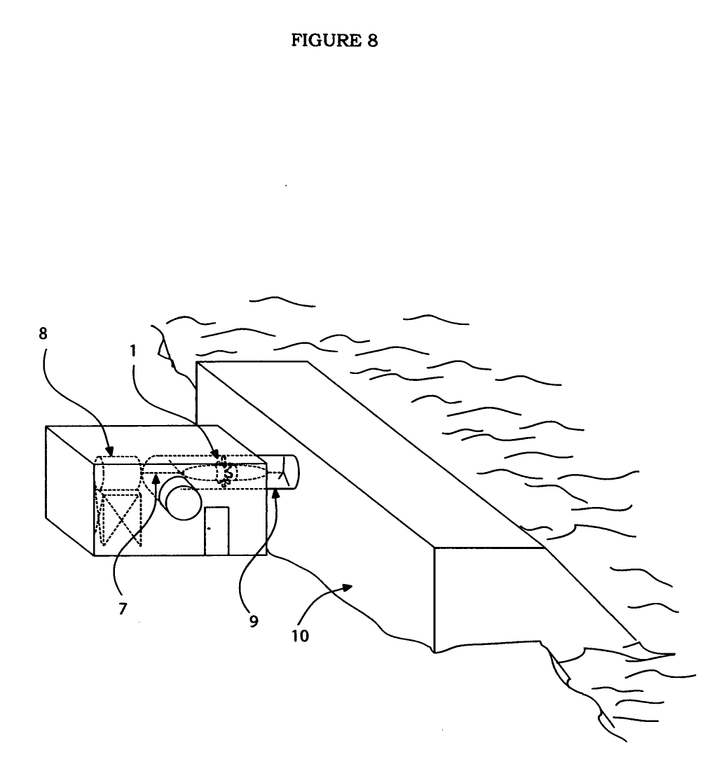

In FIG. 8 we see how the turbine is used in extracting power from sea waves, in one of its possible uses. The back to back turbine 1 is imbedded in a connecting pipe 9 that is connected to a pressure chamber 10. Where the rise and fall of water level will cause a bidirectional force. This force is rectified by the back to back turbine 1 will make the turbine rotate in one direction. The output of the turbine is applied to the electrical generator 8 using the main shaft 7.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A back to back turbine for generating useful power from sea waves or any bidirectional flow force, that is liquid or gas, comprising:
means for producing useful power from the bidirectional force of sea waves;
means for compressing and directing the flow to the blades;
means for presenting a correct pitch angle to the flow of air, no matter the direction of this flow;
means for holding the whole structure of the turbine together;
means for attaching the turbine to the axle that connects to the generator or load;
means for holding the main shaft to the main body;
means for the turbine to rotate and connect to the load; and
means for composing the back to back blade which has two blades back to back and also shield one another.

2. The back to back turbine in accordance with claim 1, wherein said means for producing useful power from the bidirectional force of sea waves comprises a back to back turbine.

3. The back to back turbine in accordance with claim 1, wherein said means for compressing and directing the flow to the blades comprises a spinner.

4. The back to back turbine in accordance with claim 1, wherein said means for presenting a correct pitch angle to the flow of air, no matter the direction of this flow comprises a back to back blade.

5. The back to back turbine in accordance with claim 1, wherein said means for holding the whole structure of the turbine together comprises a main body.

6. The back to back turbine in accordance with claim 1, wherein said means for attaching the turbine to the axle that connects to the generator or load comprises a shaft hole.

7. The back to back turbine in accordance with claim 1, wherein said means for holding the main shaft to the main body comprises a main body shaft hole.

8. The back to back turbine in accordance with claim 1, wherein said means for the turbine to rotate and connect to the load comprises a main shaft.

9. The back to back turbine in accordance with claim 1, wherein said means for composing the back to back blade which has two blades back to back and also shield one another comprises a blade.

10. A back to back turbine for generating useful power from sea waves or any bidirectional flow force, that is liquid or gas, comprising:
a back to back turbine, for producing useful power from the bidirectional force of sea waves;
a spinner, for compressing and directing the flow to the blades;
a back to back blade, for presenting a correct pitch angle to the flow of air, no matter the direction of this flow;
a main body, for holding the whole structure of the turbine together;
a shaft hole, for attaching the turbine to the axle that connects to the generator or load;
a main body shaft hole, for holding the main shaft to the main body;
a main shaft, for the turbine to rotate and connect to the load; and
a blade, for composing the back to back blade which has two blades back to back and also shield one another.

11. A back to back turbine for generating useful power from sea waves or any bidirectional flow force, that is liquid or gas, comprising:
a back to back turbine, for producing useful power from the bidirectional force of sea waves;
a spinner, for compressing and directing the flow to the blades;
a back to back blade, for presenting a correct pitch angle to the flow of air, no matter the direction of this flow;
a main body, for holding the whole structure of the turbine together;
a shaft hole, for attaching the turbine to the axle that connects to the generator or load;
a main body shaft hole, for holding the main shaft to the main body;
a main shaft, for the turbine to rotate and connect to the load; and
a blade, for composing the back to back blade which has two blades back to back and also shield one another.
